(19) United States
(12) Patent Application Publication
(10) Pub. No.: US 2015/0230511 A1
(43) Pub. Date: Aug. 20, 2015

(54) Carbonated Beverage Pressurizing System

(71) Applicant: Michael Blankenship, Santa Fe, TX (US)

(72) Inventor: Michael Blankenship, Santa Fe, TX (US)

(21) Appl. No.: 14/624,060

(22) Filed: Feb. 17, 2015

Related U.S. Application Data
(60) Provisional application No. 61/940,531, filed on Feb. 17, 2014.

(51) Int. Cl. A23L 2/54; B01F 15/02; B01F 3/04

(52) U.S. Cl. CPC A23L 2/54; B01F 3/04794; B01F 15/0243; A23V 2002/00; B01F 2215/0022

(57) ABSTRACT

A carbonated beverage storage system for preserving the carbonation in a carbonated beverage after it has been opened. The system includes reusable caps that can be secured to opened carbonated beverage containers. The reusable caps include an opening having a gasket therein that provides an airtight seal. A housing is provided that includes a bottle receiving section with a nozzle that can be inserted into the gasket of the reusable cap. An air pump is in fluid communication with the nozzle and can be used to fill the empty space within the beverage container with air in order to preserve the carbonation in the beverage. The beverage container can then be removed from the housing and the reusable cap provides a seal so that the air does not escape the bottle.

### CROSS REFERENCE TO RELATED APPLICATION

This application claims the benefit of U.S. Provisional Application No. 61/940,531 filed on Feb. 17, 2014. The above identified patent application is herein incorporated by reference in its entirety to provide continuity of disclosure.

### BACKGROUND OF THE INVENTION

### Field of the Invention

The present invention relates to a carbonated beverage pressurizing system. More specifically, the present invention provides a system for resealing and pressurizing an opened carbonated beverage container so that the beverage retains its carbonation for an extended period of time.

Carbonated beverages quickly lose their carbonation after being opened. Carbon dioxide is added to the beverage under pressure, and when the pressure is reduced, such as when the container is opened, the carbon dioxide escapes the beverage. After the beverage container has been left open for a period of time, the beverage will lose its carbonation and will become flat. Flat beverages, such as flat soda, are often unpalatable and will be discarded, which is wasteful. Furthermore, consumers may reap savings when they purchase larger volumes of a carbonated beverage, but if the consumer fails to drink the beverage after it is opened, the beverage will become flat.

Once the container has been opened, the pressure is reduced and the carbonation escapes the beverage. Even if the lid is replaced on the bottle, the beverage will continue to lose its carbonation. Thus, a device for resealing a carbonated beverage and pressurizing the container so that the beverage retains its carbonation is desired. In this way, the beverage will not become flat and can be stored for an extended period of time.

Devices are known in the prior art that relate to pressurizing devices for carbonated beverage containers. Some of these devices relate to pressurizing devices having a pump for pressurizing the container and a means for securing a cap or lid on the container, such as U.S. Pat. No. 5,439,038, U.S. Pat. No. 4,823,968, and U.S. Pat. No. 5,031,785. Other such devices disclose closure caps for containers, wherein the closure cap includes a pressurizing device, such as U.S. Pat. No. 5,294,010, U.S. Pat. No. 4,723,670, and U.S. Pat. No. 3,557,986.

These prior art devices have several known drawbacks. Such devices fail to provide a pressurizing device for carbonated beverages comprising a reusable cap having a channel with a gasket therein, wherein a pressurizing device can be removably engaged with said reusable cap so as to pressurize the beverage container, wherein the gasket provides an airtight seal when removed from the pressurizing device.

In light of the devices disclosed in the prior art, it is submitted that the present invention substantially diverges in design elements from the prior art and consequently it is clear that there is a need in the art for an improvement to existing carbonated beverage pressurizing systems for maintaining the carbonation of a beverage. In this regard the instant invention substantially fulfills these needs.

### SUMMARY OF THE INVENTION

In view of the foregoing disadvantages inherent in the known types of carbonated beverage pressurizing systems now present in the prior art, the present invention provides a new pressurizing system wherein the same can be utilized for providing convenience for the user when resealing a carbonated beverage container and preventing the beverage from losing its carbonation.

It is therefore an object of the present invention to provide a new and improved carbonated beverage pressurizing system that has all of the advantages of the prior art and none of the disadvantages.

It is another object of the present invention to provide a carbonated beverage pressurizing system comprising a reusable cap removably securable to a carbonated beverage container, and adapted to engage with a pressurizing device for filling the carbonated beverage container with air.

Another object of the present invention is to provide a carbonated beverage pressurizing system comprising a reusable cap securable to a beverage container, wherein the lid includes an opening having a gasket that provides an airtight seal.

Yet another object of the present invention is to provide a carbonated beverage pressurizing device comprising a pressurizing device with a housing having a cap receiving section adapted to engage with a reusable cap affixed to a beverage container.

A further object of the present invention is to provide a carbonated beverage pressurizing system having an air pump disposed within the pressurizing device.

Another object of the present invention is to provide a carbonated beverage pressurizing system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a reusable bottle cap of the present invention.

FIG. 2 shows a cross sectional view of the reusable bottle cap as positioned on a bottle.

FIG. 3 shows a cross sectional view of the pressurizing device of the present invention.

FIG. 4 shows a cross sectional view of an alternate embodiment of the pressurizing device of the present invention.

FIG. 5 shows a flow chart of the operation of the pressurizing device of the present invention.

### DETAILED DESCRIPTION OF THE INVENTION

Reference is made herein to the attached drawings. Like reference numerals are used throughout the drawings to depict like or similar elements of the carbonated beverage pressurizing system. For the purposes of presenting a brief and clear description of the present invention, the preferred embodiment will be discussed as used for pressurizing a carbonated beverage container that had been opened in order to preserve the beverage's carbonation. The figures are intended for representative purposes only and should not be considered to be limiting in any respect.

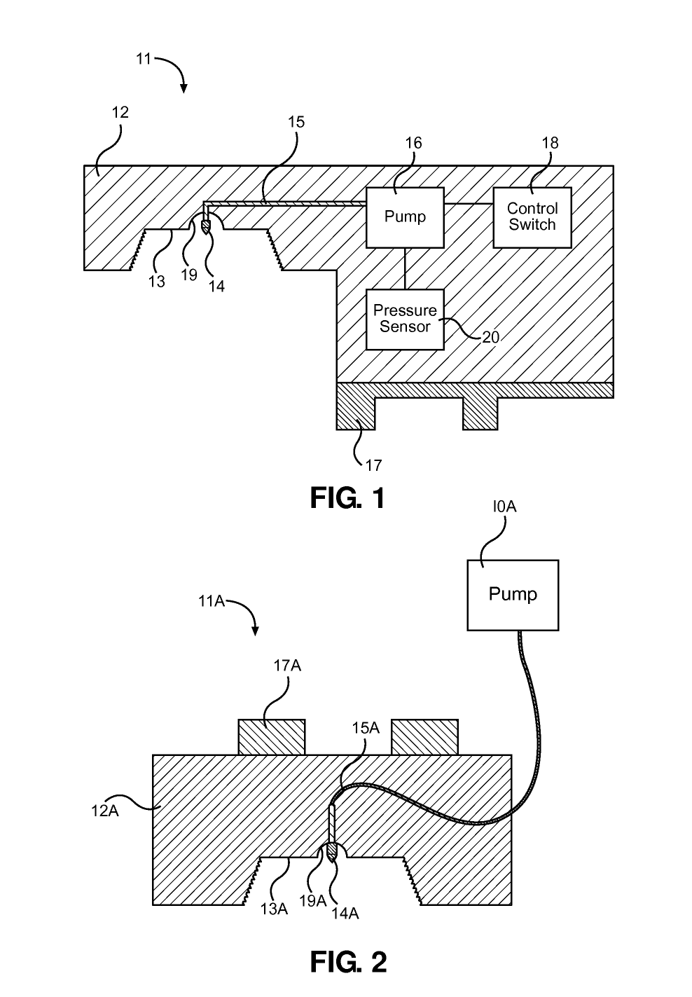

Referring now to FIGS. 1 and 2, there is shown a perspective view and a side cross sectional view of the reusable cap of the present invention, respectively. The reusable cap 21 comprises a body having an upper end 29 and a lower end 28. The lower end 28 is adapted to be secured to the open upper end 32 of a carbonated beverage container 31. The lower end 28 includes a recessed area sized similarly to the upper end of a conventional carbonated beverage container, such as a bottle, so as to receive the same therein. Thus, the body of the reusable cap 21 and the recessed area on the lower end 28 thereof preferably includes a circular cross section. The lower end 28 can be manually engaged with the open upper end 32 of a beverage container 31 by press fit or snap fit. Alternatively, the lower end 28 may include internal threading adapted to engage with the threading on the upper end 32 of the beverage container 31.

A channel 24 extends from the upper end 29 to the lower end 28 of the body of the reusable cap 21 so as to provide an air passageway from the exterior of a beverage container to the interior thereof when the reusable cap 21 is secured to a beverage container. A gasket 25 is positioned within the channel 24 and provides an airtight seal so as to prevent air from entering or escaping from the beverage container. The gasket 25 is adapted to receive a nozzle of a pressurizing device, wherein the nozzle can be used to fill the container with air through a passageway 26 of the gasket 25.

The opening 26 of the channel 24 is preferably disposed on a protrusion 27 on the upper end 29 of the body of the reusable cap 21. The protrusion 27 is illustrated as having a dome-shape, but may be provided in other configurations in alternate embodiments. The protrusion 27 is adapted to engage with a mating recess in the pressurizing device for facilitation alignment and insertion of a nozzle of the pressurizing device into the opening and gasket of the reusable cap. Thus, the pressurizing device may have a dome shaped recess adapted to receive the dome shaped protrusion 27 therein.

Further, the body of the reusable cap 21 comprises one or more lateral protrusions 22, 23 for facilitating engagement of the reusable cap 21 with the pressurizing device. Further, the lateral protrusions 22, 23 facilitate grasping the reusable cap 21 so as to allow a user to more easily secure and remove the reusable cap 21 from a beverage container. At least one lateral protrusion is provided, wherein the protrusions extend radially from the body of the reusable cap 21. In the illustrated embodiment, a first and second lateral protrusion 22, 23 are positioned on opposing sides of the reusable cap 21 such that the first and second lateral protrusions 22, 23 are aligned.

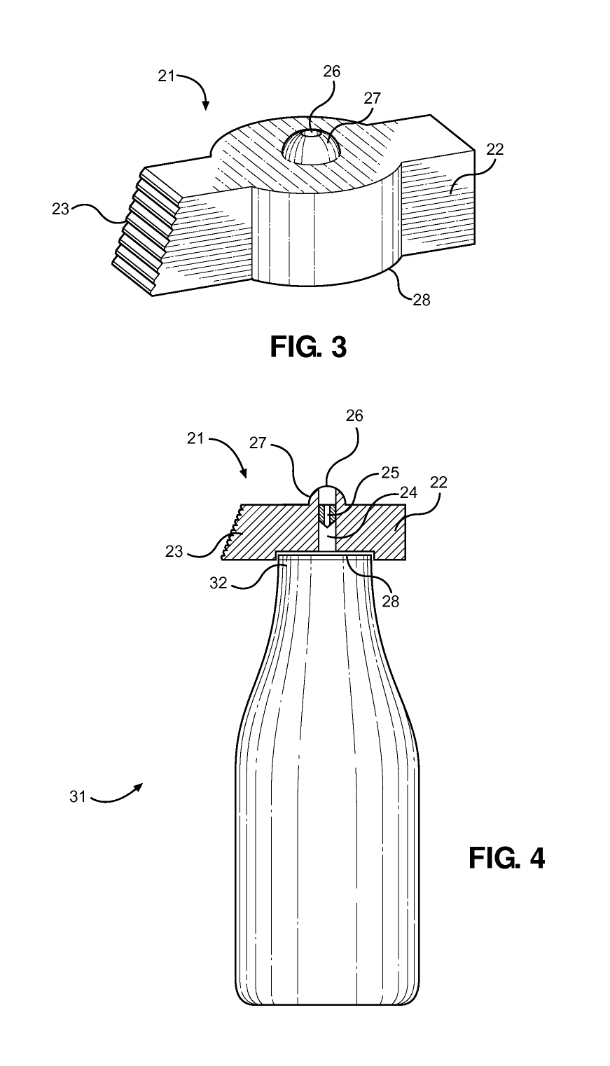

Referring now to FIGS. 3 and 4, there are shown views of embodiments of the pressurizing device of the present invention. The pressurizing device 11 comprises a housing 12 having a cap receiving section 13. The cap receiving section 13 is sized so as to receive the reusable cap of the present invention. Preferably, the cap receiving section 13 is shaped so as to mate with the reusable cap in order to provide a secure engagement therewith. The reusable cap can be secured with the cap receiving section 13 by twisting the reusable cap into position.

The cap receiving section 13 of the housing 12 preferably includes a recess 19 adapted to receive the protrusion on the upper end of the reusable cap. In the illustrated embodiment, the cap receiving section 13 includes a dome shaped recess 19 adapted to receive the dome shaped protrusion on the reusable cap. The dome shaped recess 19 includes a nozzle 14 thereon. The nozzle 14 is adapted to be aligned with and inserted into the opening and the gasket of the reusable cap. The nozzle 14 is in fluid communication with an air pump 16 via a length of tubing 15. The air pump 16 may be enclosed within the housing 12 or may be external thereto, depending upon the embodiment. Further, a control switch 18 may be provided for operating the air pump 16, such as turning the air pump 16 on and off.

In some embodiments, the pressurizing device 11 comprises a pressure sensor 20 adapted to determine the pressure inside of the beverage container. The air pump 16 is adapted to cease operation when the pressure inside of the container reaches a predetermined level. This helps to prevent overfilling or over-pressurizing the beverage container, which may lead to structural damage to the beverage container.

The housing 12 can be hand held so that a user can hold the pressurizing device 11 in one hand, and can hold a beverage container in the other. Alternatively, the housing 12 can be affixed to a wall, cabinet, or other support surface. In this way, the user does not have to support the pressurizing device 11 while it is in use. In either embodiment, the housing 12 may optionally include a bottle opening device 17. The bottle opening device 17 preferably comprises a manual bottle opening device that includes one or more protrusions adapted to engage the lid or cap of a beverage container so as to apply pressure or torque thereto in order to remove the lid or cap.

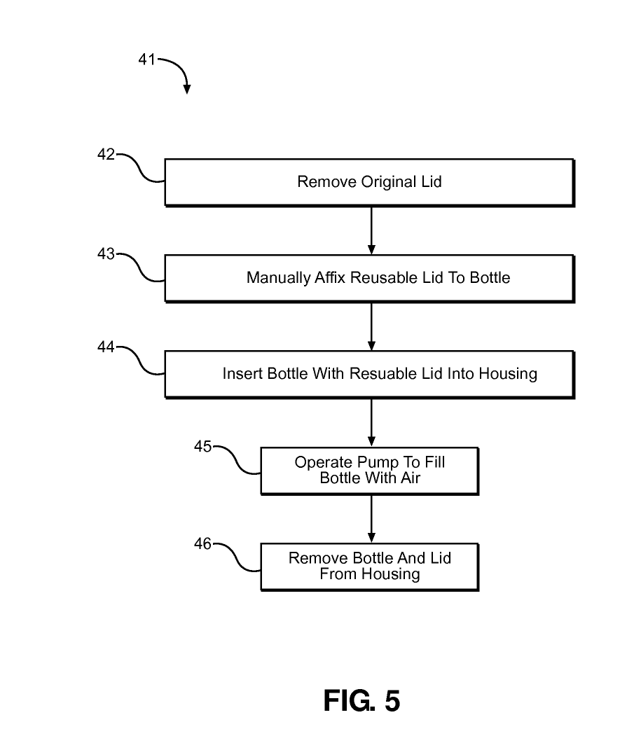

Referring now to FIG. 5, there is shown a flow chart of the operation of the carbonated beverage pressurizing system of the present invention. A method for pressurizing a carbonated beverage container 41 in order to preserve the carbonation of the beverage once it is opened is provided. In operation, the lid or cap of a carbonated beverage container can be removed therefrom so that the user may consume the beverage. However, once the beverage container is opened, the beverage begins to lose its carbonation, and simply reapplying the original lid does not prevent the carbonation from escaping the beverage.

The user can apply the reusable cap of the present invention 42. The reusable cap can be manually installed on the open end of the beverage container and may be applied via a snap fit or press fit. Alternatively, the reusable cap may include internal threading adapted to engage with the threaded opening of a beverage container. The reusable cap can be securely positioned on the beverage container and provides an airtight seal. The reusable cap includes a channel therethrough with an opening at the upper end, wherein the channel includes a gasket therein.

With the reusable cap secured thereto, the reusable cap can be engaged with the cap receiving section of the pressurizing device of the present invention. The cap receiving section is adapted to mate with the reusable cap in order to align the nozzle thereon with the opening and gasket of the reusable cap. The nozzle is positioned within the gasket so as to provide air to the interior volume of the beverage container. An air pump in fluid communication with the nozzle can be used to fill the container with air 45. The empty space within the beverage container is filled with air in order to pressurize the container, helping to prevent carbonation from escaping the beverage. In this way, the beverage will remain carbonated for an extended period of time, preventing the beverage from becoming flat and unpalatable. Once filled, the user can remove the bottle and reusable cap from the pressurizing device.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A carbonated beverage pressurizing device, comprising:
a reusable cap comprising a body with a channel extending from an upper end to a lower end of said body, said reusable cap adapted to seal a carbonated beverage container;
a gasket positioned within said channel and adapted to provide an airtight seal;
a pressurizing device comprising a housing having a cap receiving section, said cap receiving section comprising a nozzle;
an air pump in fluid communication with said nozzle, wherein said nozzle is adapted to be inserted into said gasket on said reusable cap in order to pressurize said carbonated beverage container.

2. The pressurizing device of claim 1, wherein said reusable cap comprises at least one outwardly extending lateral protrusion adapted to facilitate grasping said reusable cap.

3. The pressurizing device of claim 1, wherein said reusable cap comprises a pair of outwardly extending lateral protrusion on opposing sides thereof adapted to facilitate grasping said reusable cap.

4. The pressurizing device of claim 1, wherein said upper end of said reusable cap comprises a dome shaped portion having an opening of said channel.

5. The pressurizing device of claim 4, wherein said cap receiving section comprises a dome-shaped recess adapted to receive said dome shaped portion of said reusable cap.

6. The pressurizing device of claim 1, wherein said reusable cap can be removably engaged with said cap receiving section of said housing.

7. The pressurizing device of claim 1, wherein said air pump is positioned within said housing.

8. The pressurizing device of claim 1, wherein said housing further comprises a bottle opening device.

9. A method of pressurizing a carbonated beverage container, comprising the steps of:
providing a reusable cap comprising a body having an opening that extends from an upper end to a lower end thereof, and wherein said opening comprises a gasket therein adapted to seal said opening;
securing said reusable cap on the opening of a carbonated beverage container;
providing a pressurizing device having an air pump in fluid communication with a nozzle;
inserting said nozzle into said gasket of said reusable cap;
filling said carbonated beverage container with air in order to pressurize said carbonated beverage container;
removing said carbonated beverage container from said pressurizing device.
